(19) United States
(12) Patent Application Publication
(10) Pub. No.: US 2012/0167359 A1
(43) Pub. Date: Jul. 5, 2012

(54) COFFIN

(75) Inventors: Khee Yang Ng, Singapore (SG); Kok Kin Ting, Singapore (SG); Kay Heng Teo, Singapore (SG); Boon Tee Desmond Lim, Singapore (SG)

(73) Assignee: Tent Tech Pte Ltd, Singapore (SG)

(21) Appl. No.: 13/496,371

(22) PCT Filed: Sep. 17, 2010
(86) PCT No.: PCT/SG10/00344

§ 371 Date: Mar. 15, 2012

(30) Foreign Application Priority Data
Sep. 18, 2009 (SG) 200906235-7

(51) Int. Cl. A61G 17/007; A61G 17/02; A61G 17/00

(52) U.S. Cl. 27/3; 27/2

(57) ABSTRACT

A coffin comprising a first side wall, a second side wall, a first end wall, a second end wall, a composite base and reinforcing layers along the sides, ends and the corners, wherein the composite base and the reinforcing layers are adapted to provide structural enhancement to the coffin.

### FIELD OF THE INVENTION

This invention relates to coffins made of wooden derivatives and has particular and not exclusive use during disasters and emergencies.

### BACKGROUND OF THE INVENTION

Emergencies and disasters are big concerns for the nations, not only in terms of loss of lives alone, but also with regards to disposing the dead as quickly as possible to maintain sanitation, hygiene and prevent the trigger of epidemics. Another concern may be providing the dead a “decent” burial or cremation. Typically, in the aftermath of emergencies, body bags are used to dispose the dead as quickly as possible. To handle someone in a body bag, this may not be sufficient to provide someone with what may be considered a decent burial and cremation. Another problem with body bags is the possibility of them tearing apart due to rough handling. This can expose the bodies inside and result in the spread of infections and offensive odour. Additionally, most cremators need to use a board/box for handling body bags, as body bags are not firm and cannot support the weight of bodies when lifted.

The usage and manufacture of cardboard coffins is already disclosed. However, a structure made purely of cardboard tends to be flimsy and the load carrying characteristics are not good. This particular characteristic might lead to handling issues.

If wooden coffins are used during emergencies and are subsequently cremated, the coffin takes a long time to burn, the burning time being a function of the type of wood used. This will not be preferred as there may be lot of bodies for cremation. Moreover with wooden coffins, there will be issues with their storage and transportation because of their bulky nature and weight.

Wooden coffins, even if they are transported in a disassembled state will take a long time to be assembled. In some cases, additional equipments like a jig might also be required if numerous coffins are to be assembled in a short span of time.

### SUMMARY

The invention is defined in the independent claim. Some optional features of the invention are defined in the dependent claims.

### BRIEF DESCRIPTION OF THE DRAWINGS

The accompanying drawings illustrate the invention, by way of example only and together with the description, serve to explain the principles of the invention.

FIG. 1a is a plan view of a first coffin

FIG. 1b is a plan view of a second coffin with a double wall

FIG. 2 is an elevation view of any of the coffins of FIG. 1a to 1b with a base

FIG. 3a is a plan view of the coffin if FIG. 1a with a reinforcing layer

FIG. 3b is a plan view of the coffin in FIG. 1b with a reinforcing layer.

FIG. 4a is a cross section of a single ply carton box material

FIG. 4b is a cross section of a double ply carton box material

FIG. 5a is a view of a first underside of a lid of any of the coffins of FIG. 1a to 1b

FIG. 5b is a view of a second underside of a lid of any of the coffins of FIG. 1a to 1b

FIG. 6 is an elevation view of any of the coffins of FIG. 1a to 1b with the fluid impermeable tray

### DETAILED DESCRIPTION

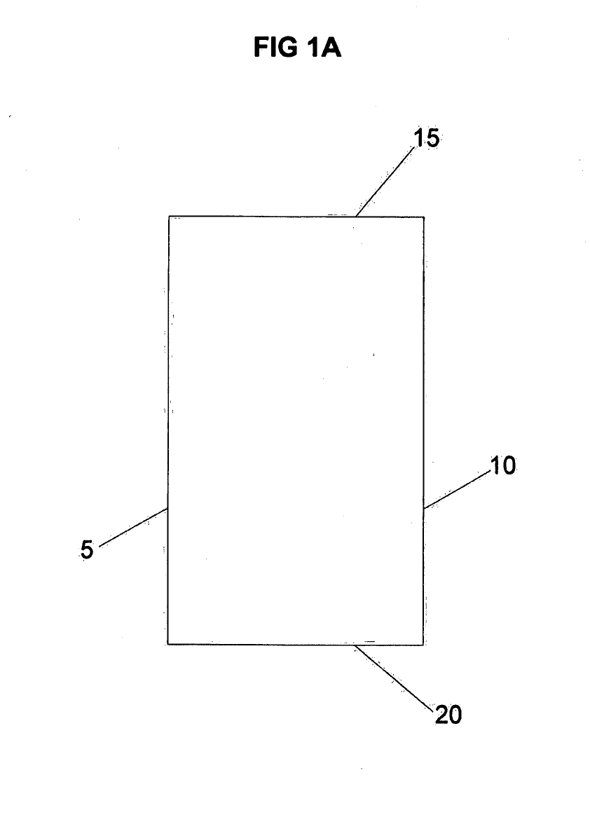

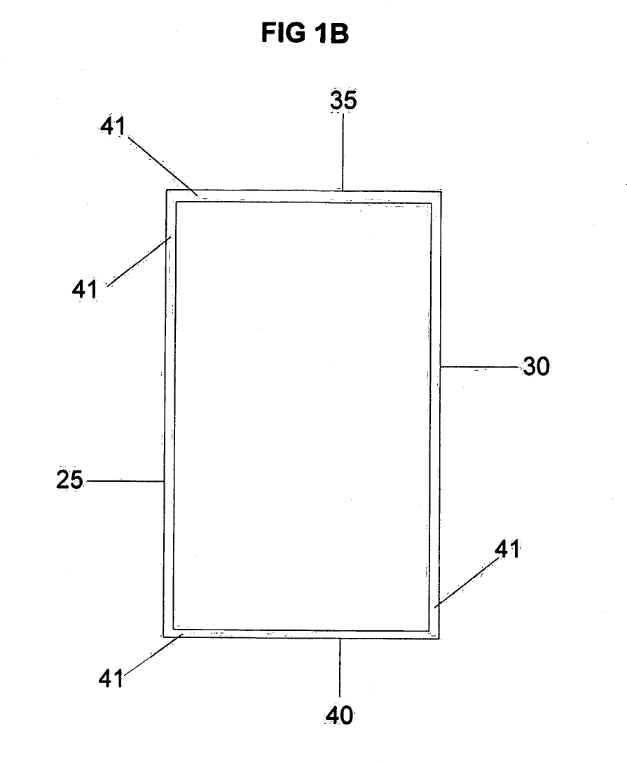

FIG. 1a is a plan view of a first coffin. The coffin has a first side wall 5, a second side wall 10, a first end wall 15 and a second end wall 20. The side walls and end walls of the coffin are made of carton box material. Alternatively, they may be made of other wooden derivatives such as cardboard, composite wood, hardboard etc. FIG. 1a illustrates a rectangular coffin, but it can be of any shape.

FIG. 1b is a plan view of a second coffin. The coffin has a first side wall 25, a second side wall 30, a first end wall 35 and a second end wall 40. Each of the walls indicated above comprise a double wall with a gap 41 between the two layers of the wall. The purpose of the gap will be described hereinafter. The side walls and end walls of the coffin are made of carton box material. Alternatively, they may be made of other wooden derivatives such as cardboard, composite wood, hardboard etc. FIG. 1b illustrates a rectangular coffin, but it can be of any shape.

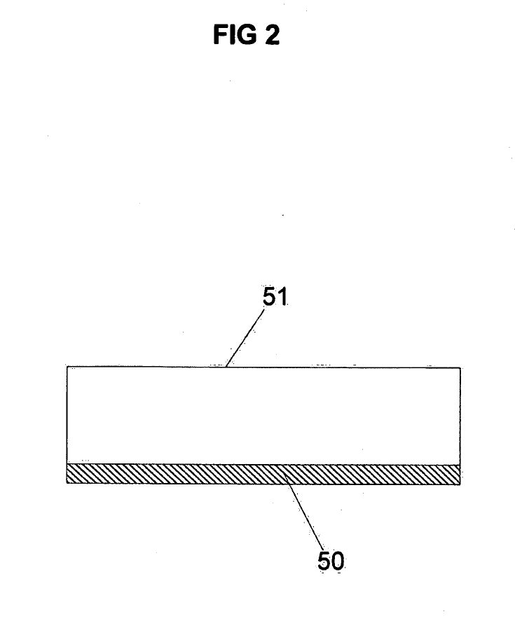

FIG. 2 is an elevation view of any of the above coffins shown with a base. The base 50 is a composite base and is made of either carton box material and wood or wooden derivatives and wood. Additionally, the composite base may also contain plastic. The different materials are arranged in layers. The layers may be arranged in any suitable order. The advantage provided by the composite base is that it reinforces the structure of the coffin to support the weight of the body inside the coffin. A base made only of carton box material or cardboard will not be able to support the weight of the body inside the coffin. The first and the second coffin each have a top end 51 as illustrated in FIG. 2, the top end 51 comprising the upper edges of the walls 5, 10, 15 and 20 of the first coffin and the walls 25, 30, 35 and 40 of the second coffin.

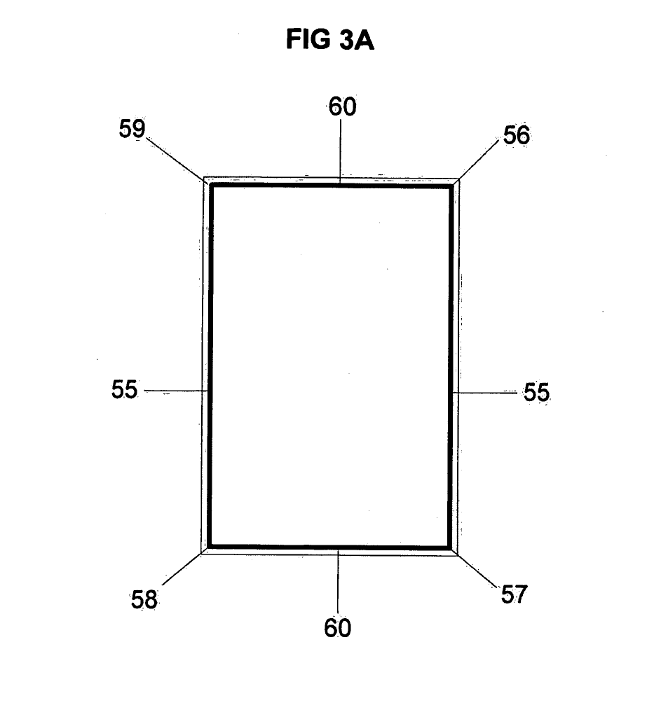

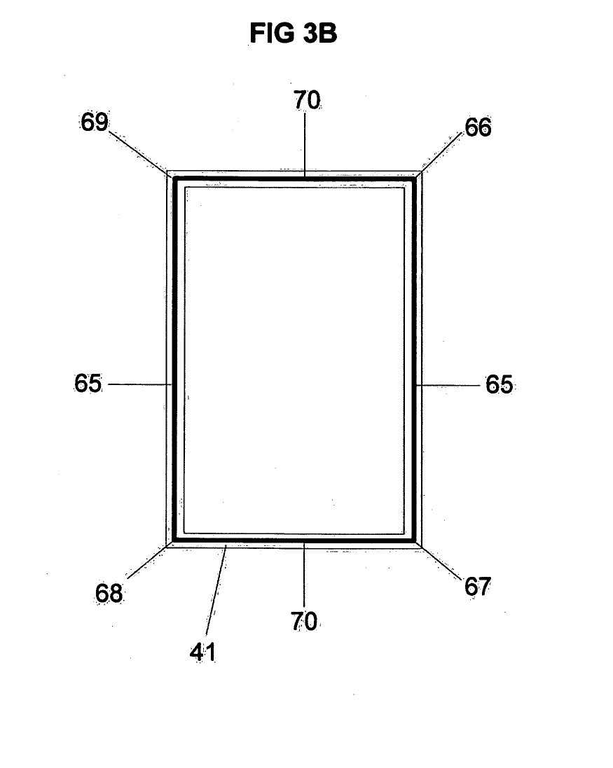

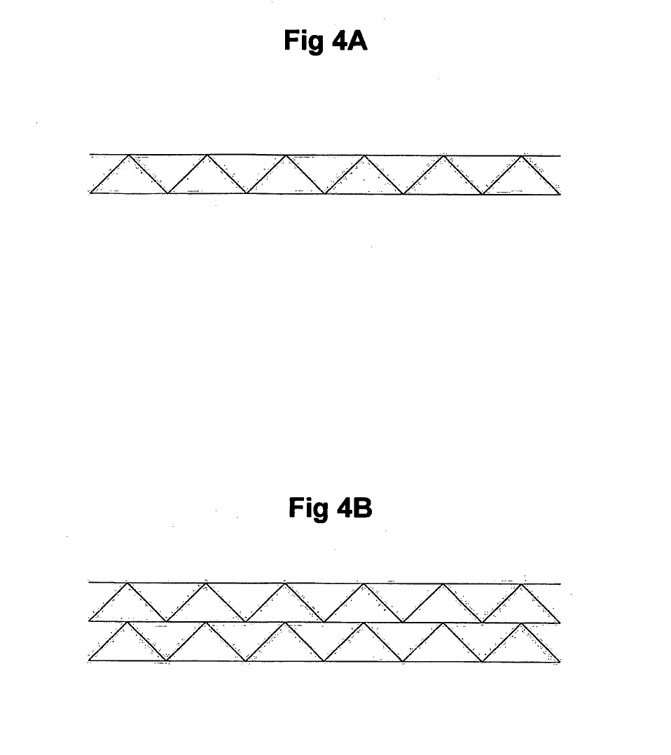

FIG. 3a is a plan view of the first coffin with a first and second reinforcing layer. As illustrated in FIG. 3a, a first reinforcing layer 55 is positioned adjacent the first side wall 5 and the second side wall 10. Moreover, a second reinforcing layer 60 is positioned adjacent the first end wall 15 and the second end wall 20. The reinforcing layers 55 and 60 are made of carton box material, which may be a single ply carton box material or a double ply carton box material. A single ply and a double ply carton box material are illustrated in FIG. 4a and FIG. 4b. A double ply carton box material is stronger and sturdier than a single ply carton box material. The reinforcing layers may be fastened to the side and end walls by suitable fastening materials such as glue, screws or other mechanical fasteners. Alternatively, the reinforcing layers can also be made of plastic or wooden derivatives such as cardboard, composite wood, hardboard etc. The reinforcing layers are adapted to reinforce the structure of the coffin to support the weight of the body inside the coffin. The positioning of the reinforcing layers is not limited to the above arrangement alone. The reinforcing layers can be arranged in any suitable way which provides structural reinforcement to the coffin.

Moreover, apart from the first and second reinforcing layers which span the side walls and end walls of the coffin, there are corner reinforcing strips 56, 57, 58 and 59 which are arranged to reinforce only the corners of the first coffin. These are elongated thin strips that fit in the corner between a reinforcing layer spanning the side wall and a reinforcing layer spanning the end wall. The reinforcing strips extend from the top end 51 to the base 50 of the coffin. These may be made of the same material as the first and second reinforcing layers 55 and 60. The corners also have to be reinforced along with the side walls and the end walls to prevent any weakness from developing in the corners. Weaknesses can cause the coffin structure to collapse. Alternatively, the reinforcing layers can be arranged such that it covers the corners as well, such as a type of a reinforcing layer which spans a side wall and an end wall partially, passing through an intersecting corner. The other type may be a reinforcing layer that spans two end walls partially and a side wall completely. Yet another type may be a reinforcing layer that spans two side walls partially and an end wall completely.

FIG. 3b is a plan view of the second coffin with a third and fourth reinforcing layer. As illustrated in FIG. 1b, the gap 41 between the two layers of the first and second side wall 25 and 30 holds a third reinforcing layer 65. Similarly, the gap 41 between the two layers of the first and second end walls 35 and 40 serves to hold a fourth reinforcing layer 70. The reinforcing layers are made of carton box material, which may be a single ply carton box material or a double ply carton box material. A single ply and a double ply carton box material are illustrated in FIG. 4a and FIG. 4b. Alternatively, the reinforcing layers can also be made of plastic or wooden derivatives such as cardboard, composite wood, hardboard etc. The reinforcing layers are adapted to further reinforce the structure of the coffin to support the weight of the body inside the coffin.

Moreover, apart from the third and fourth reinforcing layers which span the side walls and end walls of the coffin, there are corner reinforcing strips 66, 67, 68 and 69 which are arranged to reinforce only the corners of the second coffin. These are elongated thin strips that fit in the corner between a reinforcing layer spanning the side wall and a reinforcing layer spanning the end wall. The reinforcing strips extend from the top end 51 to the base 50 of the coffin. These may be made of the same material as the first and second reinforcing layers 65 and 70. The corners also have to be reinforced along with the side walls and the end walls to prevent any weakness from developing in the corners. Weaknesses can cause the coffin structure to collapse. Alternatively, the reinforcing layers may be arranged such that it covers the corners as well, such as a type of a reinforcing layer which spans a side wall and an end wall partially, passing through the intersecting corner. The other type may be a reinforcing layer that spans two end walls partially and a side wall completely. Yet another type may be a reinforcing layer that spans two side walls partially and an end wall completely.

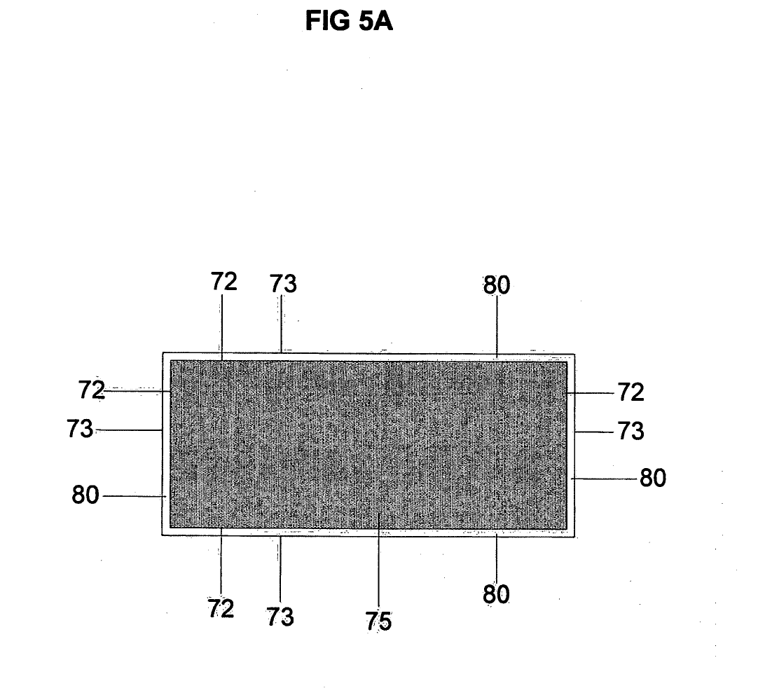

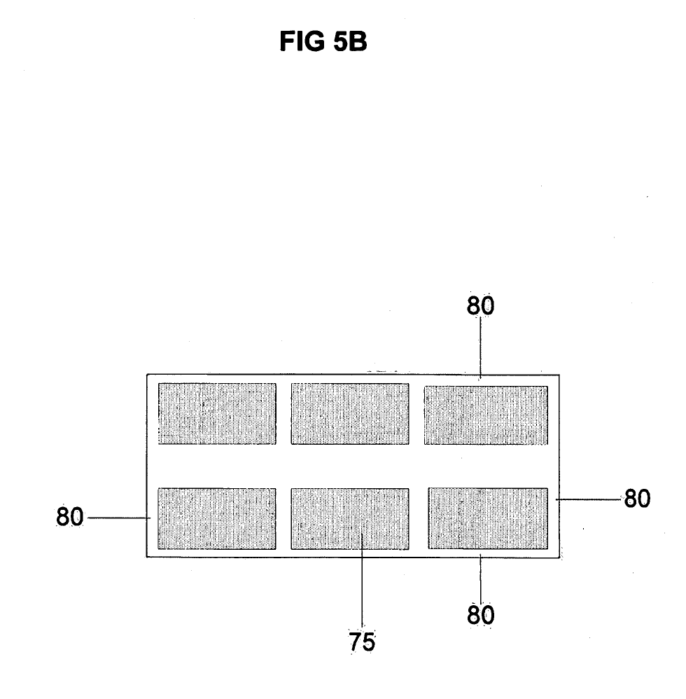

FIG. 5a illustrates the underside of a lid 71 of the first coffin or the second coffin. The structure comprises a single block 75 made of any material like cardboard or wood. The block is such that when attached to the underside of the lid, it causes a gap 80 to be created between edges 72 of the block 75 and edges 73 of the lid 71, such that the gap receives the top end 51 of the coffin. This feature provides a further structural enhancement of the coffin when it is being carried by creating a good fit between the lid and the top end of the coffin. Alternately, the block can also be in the form of a multitude of pieces as is illustrated in FIG. 5b, wherein the gap 80 is created. The shape and arrangement of the blocks are not limited by the above mentioned structures alone. The lid is made of either cardboard or carton box material or wood.

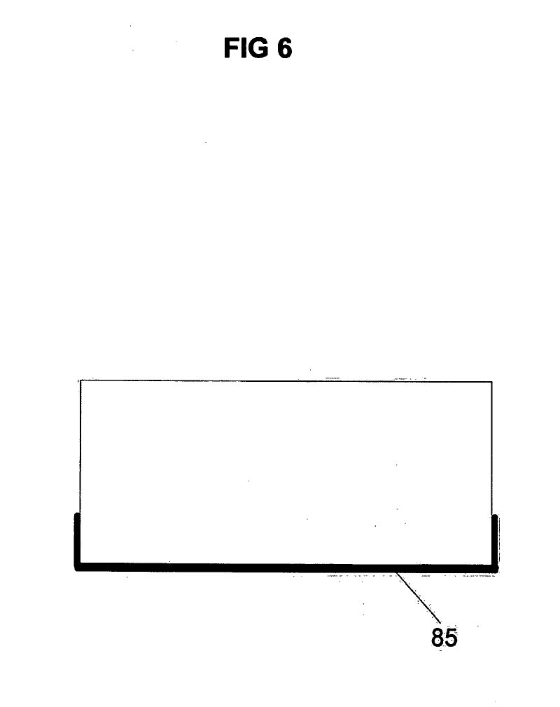

FIG. 6 illustrates a fluid impermeable tray 85 being a platform on which the coffin is placed. The tray is fluid impermeable to prevent fluids from outside damaging the base of the coffin. The fluid impermeable tray is made of materials such as plastic etc. The tray can also be used as a cover for the coffin to view the deceased.

It is to be understood that the foregoing description of several preferred embodiments is intended to be purely illustrative of the principles of the invention, rather than exhaustive thereof, and that changes and variations will be apparent to those skilled in the art, and that the present invention is not intended to be limited other than as expressly set forth in the following claims.

1. A coffin comprising:
a first end wall;
a second end wall;
a first side wall;
a second side wall; and
a composite base, wherein each of the first side wall, second side wall, first end wall and the second end wall includes a double wall with a gap for receiving a reinforcing layer.

2. The coffin as claimed in claim 1, the composite base comprising carton box material and wood.

3. The coffin as claimed in claim 1, the composite base comprising wooden derivative and wood.

4. The coffin as claimed in claim 2, wherein the composite base further includes plastic.

5. The coffin as claimed in claim 1, comprising a first reinforcing layer adjacent the first side wall and the second side wall.

6. The coffin as claimed in claim 5, comprising a second reinforcing layer adjacent the first end wall and the second end wall.

7. The coffin as claimed in claim 5, comprising reinforcing strips in the corners of the coffin.

8. The coffin as claimed in claim 5, wherein the first reinforcing layer is being arranged to extend to any one of the first end wall and the second end wall by passing through an intersecting corner.

9. The coffin as claimed in claim 6, wherein the second reinforcing layer is being arranged to extend to any one of the first side wall and the second side wall by passing through an intersecting corner.

10. (canceled)

11. The coffin as claimed in claim 1, comprising a third reinforcing layer positioned in the gap of the first side wall and the gap of the second side wall.

12. The coffin as claimed in claim 1, comprising a fourth reinforcing layer positioned in the gap of the first end wall and the gap of the second end wall.

13. The coffin as claimed in claim 11, comprising reinforcing strips in the corners of the coffin.

14. The coffin as claimed in claim 11, wherein the third reinforcing layer is being arranged to extend to any one of the first end wall and the second end wall by passing through an intersecting corner.

15. The coffin as claimed in claim 12, wherein the fourth reinforcing layer is being arranged to extend to any one of the first side wall and the second side wall by passing through an intersecting corner.

16. The coffin as claimed in claim 5, the reinforcing layer comprising any one of a double ply carton box material, single ply carton box material, wooden derivative and plastic.

17. The coffin as claimed in claim 1, the coffin having a lid with an underside, the underside having a structure being arranged on the underside to create a gap for receiving a top end of the coffin.

18. The coffin as claimed in claim 1, comprising a fluid impermeable tray, the fluid impermeable tray being a platform for the coffin.

19. The coffin as claimed in claim 14, wherein the third reinforcing layer spans the first and second side walls partially and one of the first end wall and the second end wall completely.

20. The coffin as claimed in claim 15, wherein the fourth reinforcing layer spans the first and second end walls partially and one of the first side wall and the second side wall completely.

22. The coffin as claimed in claim 1, wherein the first and second side walls, and the first and second end walls are made of one of: carton box material, cardboard, composite wood and hardboard.

23. A cardboard coffin comprising:
a first end wall;
a second end wall;
a first side wall;
a second side wall; and
a base;
wherein each of the first side wall, second side wall, first end wall and the second end wall includes a double wall with a gap for receiving a reinforcing layer.

24. The cardboard coffin as claimed in claim 23 wherein the first and second side walls, and the first and second end walls are made of one of: carton box material, cardboard, composite wood and hardboard.
